(19) United States
(12) Patent Application Publication
(10) Pub. No.: US 2006/0092877 A1
(43) Pub. Date: May 4, 2006

(54) Data transport in GSM system

(75) Inventor: Kari Niemela, Oulu (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: NOKIA CORPORATION

(21) Appl. No.: 11/253,711

(22) Filed: Oct. 20, 2005

Related U.S. Application Data
(60) Provisional application No. 60/620,282, filed on Oct. 21, 2004.

(51) Int. Cl. H04Q 7/00

(52) U.S. Cl. 370/330

(57) ABSTRACT

A solution for transporting data in a GSM system is provided. According to the solution a network assigns a number of frequency channels to a subscriber terminal, which may then use multiple frequency channels for simultaneous transport of data. If the subscriber terminal is capable of transporting data using multiple input multiple output transmission, this capability could also be used in the transport of data.

### CROSS-REFERENCE TO RELATED APPLICATION

This non-provisional application claims the benefit of U.S. provisional Application No. 60/620,282, filed on Oct. 21, 2004. The disclosure of the prior application is hereby incorporated by reference herein in its entirety.

### FIELD

The invention relates to a method of transmitting data blocks in a radio system from a first transceiver to a second transceiver, and to a radio system employing the method. Both the method and the radio system employing the method are particularly suited for Global System for Mobile Communications (GSM).

### BACKGROUND

Transmitters and receivers used in a radio system typically form transceivers, examples of which include transceivers in subscriber terminals, such as mobile phones, and transceivers of a base station.

EGPRS (Enhanced General Packet Radio Service) is a GSM-based (Global System for Mobile Communications) system utilizing packet-switched transmission. EGPRS uses EDGE (Enhanced Data Rates for GSM Evolution) technology to increase data transmission capacity. In addition to GMSK (Gaussian Minimum-Shift Keying) modulation normally used in GMS, 8-PSK (8-Phase Shift Keying) modulation can be used for packet data channels. The aim is mainly to implement non-real-time data transmission services, such as file copying and use of an Internet browser. A further aim is to implement packet-switched real-time services for instance to transmit speech and video. In principle, the data transmission capacity can vary from a few kilobits per second up to 400 kilobits per second. This data transmission capacity may not, however, be enough for some services provided by network operators, and ever increasing demand for higher bit rates requires further development of the EGPRS.

### BRIEF DESCRIPTION OF THE INVENTION

An object of the invention is to provide improved solutions for transport of data in a GSM system.

According to an aspect of the invention, there is provided a data transmission method for a Global System for Mobile Communications, the method comprising providing a subscriber terminal capable of transporting of data using multiple carrier signals with at least two frequency channels for transport of data, allocating time slots in a Global System for Mobile Communications frame for the frequency channels provided to a subscriber terminal, and transporting data according to the allocated time slots using the frequency channels provided to the subscriber terminal.

According to another aspect of the invention, there is provided a subscriber terminal for a Global System for Mobile Communications, the subscriber terminal comprising at least one transmitter for transmitting data, at least one receiver for receiving data, and a control unit configured to receive a command to use at least two specified frequency channels for transport of data, receive a command to use specified time slots in a Global System for Mobile Communications frame for the provided frequency channels, and transport data according to the allocated time slots using the provided frequency channels.

According to another aspect of the invention, there is provided a network element for a Global System for Mobile Communications, the network element comprising at least one transmitter for transmitting data, at least one receiver for receiving data, and a control unit configured to provide a subscriber terminal with at least two frequency channels for transport of data, allocate time slots in a Global System for Mobile Communications frame for the frequency channels provided to a subscriber terminal, and transport data according to the allocated time slots using the frequency channels provided to the subscriber terminal.

According to another aspect of the invention, there is provided an arrangement for a Global System for Mobile Communications, comprising a subscriber terminal and a network element that are in radio contact with each other; the subscriber terminal comprising means for receiving a command to use at least two specified frequency channels for transport of data, means for receiving a command to use specified time slots in a Global System for Mobile Communications frame for the provided frequency channels, and means for transporting data according to the allocated time slots using the provided frequency channels; the network element comprising means for providing the subscriber terminal with at least two frequency channels for transport of data, means for allocating time slots in the Global System for Mobile Communications frame for the frequency channels provided to a subscriber terminal, and means for transporting data according to the allocated time slots using the frequency channels provided to the subscriber terminal.

According to another aspect of the invention, there is provided a computer program product encoding a computer program of instructions for executing a computer process for transporting data in a Global System for Mobile Communications, the process comprising: providing a subscriber terminal capable of transporting data using multiple carrier signals with at least two frequency channels for transport of data, allocating time slots in a Global System for Mobile Communications frame for the frequency channels provided to a subscriber terminal, and transporting data according to the allocated time slots using the frequency channels provided to the subscriber terminal.

According to another aspect of the invention, there is provided a computer program distribution medium readable by a computer and encoding a computer program of instructions for executing a computer process for transporting data in a Global System for Mobile Communications, the process comprising providing a subscriber terminal capable of transporting data using multiple carrier signals with at least two frequency channels for transport of data, allocating time slots in a Global System for Mobile Communications frame for the frequency channels provided to a subscriber terminal, and transporting data according to the allocated time slots using the frequency channels provided to the subscriber terminal.

According to another aspect of the invention, there is provided a data transmission method for a Global System for Mobile Communications, the method comprising providing a subscriber terminal capable of transporting data using multiple carrier signals with at least one frequency channel for transport of data, indicating to the subscriber terminal that the provided at least one frequency channel is to be used for multiple input multiple output transmission of data, determining the number of multiple input multiple output transmission paths between the subscriber terminal and a base station, allocating time slots in a Global System for Mobile Communications frame for the multiple input multiple output transmission paths, and transporting data according to the allocated time slots provided to a subscriber terminal using multiple input multiple output transmission.

According to another aspect of the invention, there is provided a subscriber terminal for a Global System for Mobile Communications, the subscriber terminal comprising at least one transmitter for transmitting data, at least one receiver for receiving data, and a control unit configured to receive a command to use at least one specified frequency channel for transport of data, receive an indication to use the at least one specified frequency channel for multiple input multiple output transmission of data, receive a number of multiple input multiple output transmission paths to be used in the transmission or reception, receive a command to use specified time slots in a Global System for Mobile Communications frame for the multiple input multiple output transmission paths, and transport data according to the allocated time slots provided to a subscriber terminal using multiple input multiple output transmission.

According to another aspect of the invention, there is provided a network element for a Global System for Mobile Communications, the network element comprising at least one transmitter for transmitting data, at least one receiver for receiving data, and a control unit configured to provide a subscriber terminal capable of transporting data using multiple carrier signals with at least one frequency channel for transport of data, indicate the subscriber terminal that the provided at least one frequency channel is to be used for multiple input multiple output transmission of data, determine the number of multiple input multiple output transmission paths between the subscriber terminal and a base station, allocate time slots in a Global System for Mobile Communications frame for the multiple input multiple output transmission paths, and transport data according to the allocated time slots provided to a subscriber terminal using multiple input multiple output transmission.

According to another aspect of the invention, there is provided an arrangement for a Global System for Mobile Communications, comprising a subscriber terminal and a network element that are in radio contact with each other; the subscriber terminal comprising means for receiving a command to use at least one specified frequency channel for transport of data, means for receiving an indication to use the at least one specified frequency channel for multiple input multiple output transmission of data, means for receiving a number of multiple input multiple output transmission paths to be used in the transmission or reception, means for receiving a command to use specified time slots in a Global System for Mobile Communications frame for the multiple input multiple output transmission paths, and means for transporting data according to the allocated time slots provided to the subscriber terminal using multiple input multiple output transmission; the network element comprising means for providing a subscriber terminal capable of transporting data using multiple carrier signals with at least one frequency channel for transport of data, means for indicating to the subscriber terminal that the provided at least one frequency channel is to be used for multiple input multiple output transmission of data, means for determining the number of multiple input multiple output transmission paths between the subscriber terminal and a base station, means for allocating time slots in a Global System for Mobile Communications frame for the multiple input multiple output transmission paths, and means for transporting data according to the allocated time slots provided to a subscriber terminal using multiple input multiple output transmission.

According to another aspect of the invention, there is provided a computer program product encoding a computer program of instructions for executing a computer process for transporting data in a Global System for Mobile Communications, the process comprising providing a subscriber terminal capable of transporting data using multiple carrier signals with at least one frequency channel for transport of data, indicating to the subscriber terminal that the provided at least one frequency channel is to be used for multiple input multiple output transmission of data, determining the number of multiple input multiple output transmission paths between the subscriber terminal and a base station, allocating time slots in a Global System for Mobile Communications frame for the multiple input multiple output transmission paths, and transporting data according to the allocated time slots provided to a subscriber terminal using multiple input multiple output transmission.

According to another aspect of the invention, there is provided a computer program distribution medium readable by a computer and encoding a computer program of instructions for executing a computer process for transporting data in a Global System for Mobile Communications, the process comprising, providing a subscriber terminal capable of transporting data using multiple carrier signals with at least one frequency channel for transport of data, indicating to the subscriber terminal that the provided at least one frequency channel is to be used for multiple input multiple output transmission of data, determining the number of multiple input multiple output transmission paths between the subscriber terminal and a base station, allocating time slots in a Global System for Mobile Communications frame for the multiple input multiple output transmission paths, and transporting data according to the allocated time slots provided to a subscriber terminal using multiple input multiple output transmission.

The invention provides several advantages. The invention provides considerably higher bit rates for the GSM standard by utilizing multicarrier technology. The invention also enables multiple input multiple output transmission of data in a GSM system. By employing multiple input multiple output transmission of data in a GSM system bit rates are also considerably higher compared to those in existing GSM systems.

### LIST OF DRAWINGS

In the following, the invention will be described in greater detail with reference to the embodiments and the accompanying drawings, in which

FIG. 1 shows a block diagram of a communication system;

FIG. 2A illustrates an example of a structure of a subscriber terminal according to the invention;

FIG. 2B illustrates an example of a structure of a subscriber terminal according to the invention;

FIG. 3A illustrates an example of a layered structure of a subscriber terminal according to the invention;

FIG. 3B illustrates an example of a layered structure of a network element according to the invention;

FIG. 4A illustrates an example of allocation of time slots in a GSM frame for a subscriber terminal using a dual receiver;

FIG. 4B illustrates an example of allocation of time slots in a GSM frame for a subscriber terminal using a dual receiver with simultaneously active circuit switched and packet switched connection;

FIG. 5 illustrates a subscriber terminal utilizing an MIMO connection; and a subscriber terminal utilizing an MISO connection;

FIG. 6 is a flow diagram describing a process for transporting data using multiple frequency channels for one subscriber terminal in a GSM system; and

FIG. 7 is a flow diagram describing a process for transporting data using multiple input multiple output transmission is a GSM system.

### DESCRIPTION OF EMBODIMENTS

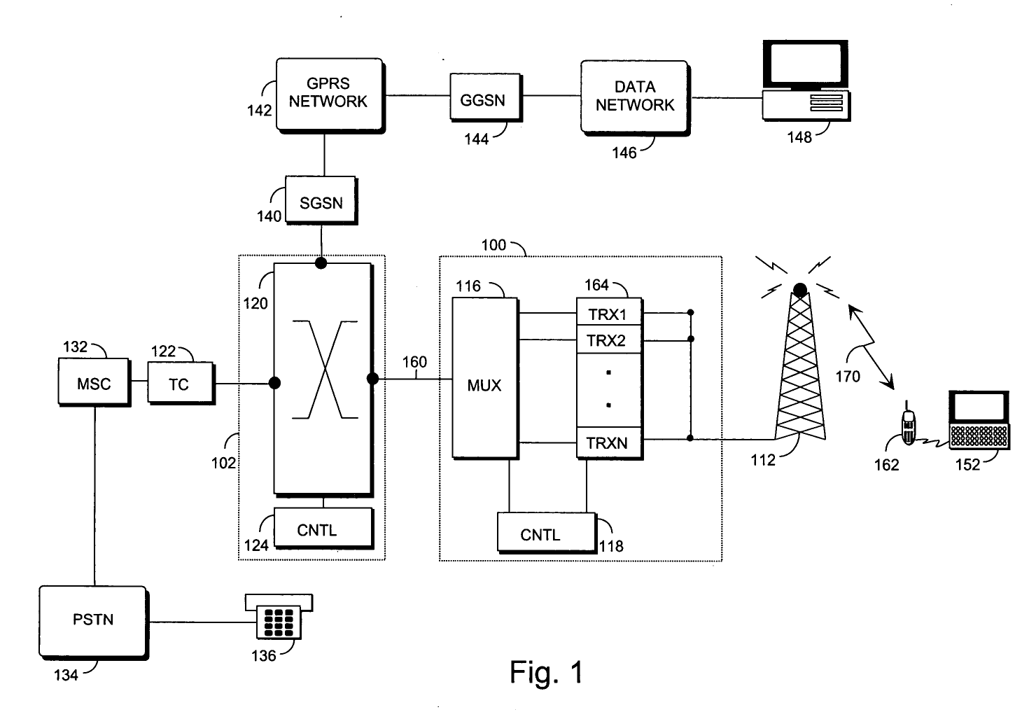

A typical structure of a radio system according to preferred embodiments and its interfaces with a fixed telephone network and a packet-switched network are described with reference to FIG. 1. FIG. 1 only contains blocks that are essential to explaining the embodiments, but it is clear to a person skilled in the art that a conventional cellular packet network also contains other functions and structures that need not be explained in more detail herein. The invention is most preferably used in a GSM system which incorporates EDGE.

A cellular network typically comprises a fixed network infrastructure, i.e. a network part, and as transceivers 162 subscriber terminals, which can be fixed, installed in a vehicle or portable terminals. The network part includes base stations 100. A base station controller 102 connected to several base stations 100 controls them in a centralized manner. The base station 100 includes transceivers 164. A base station 100 typically includes one to sixteen transceivers 164. One transceiver 164 provides radio capacity for one TDMA (Time Division Multiple Access) frame, i.e. typically for eight time-slots.

The base station 100 comprises a control unit 118 that controls the operation of the transceivers 164 and a multiplexer 116. The multiplexer 116 switches traffic and control channels used by several transceivers 164 on one transmission link 160. The structure of the transmission link 160 is exactly defined, and it is called an Abis interface.

The transceivers 164 of the base station 100 are connected to an antenna unit 112, which establishes a bi-directional radio link 170 to the subscriber terminal 162. The structure of frames transmitted on the bi-directional radio link 170 is also exactly defined, and it is called an air interface.

The subscriber terminal 162 can be a normal mobile phone, for instance, and a portable computer 152, for instance, can be attached to it by means of an expansion card and used in ordering and processing packets in packet transmission.

The base station controller 102 comprises a switching field 120 and a control unit 124. The switching field 120 is used for switching speech and data and for connecting signaling circuits. A base station system made up of the base station 100 and the base station controller 102 also comprises a transcoder 122. The transcoder 122 usually resides as close to a mobile switching center 132 as possible, because it is then possible to transmit speech in cellular network format between the transcoder 122 and the base station controller 102, thus saving transmission capacity.

The transcoder 122 transforms different digital speech coding formats used between a public switched telephone network and a radio telephone network to suit each other, for instance from the 64 kbit/s format of a fixed network to a cellular radio network format (e.g. 13 kbit/s) and vice versa. The control unit 124 takes care of call control, mobility management, collection of statistics, and signaling.

As shown in FIG. 1, connections (shown as black dots) can be set up with the switching field 120 both to a public switched telephone network 134 through a mobile switching center 132 and to a packet-switched network 142. A typical terminal 136 in the public switched telephone network 134 is a conventional phone or an ISDN (Integrated Services Digital Network) phone.

The connection between the packet transmission network 142 and the switching field 120 is established by a serving GPRS support node (SGSN) 140. A task of the serving GPRS support node 140 is to transmit packets between the base station system and a gateway GPRS support node (GGSN) 144, and to record the position of the subscriber terminal 162 in its area.

The gateway GPRS support node 144 connects a public packet transmission network 146 and the packet transmission network 142. An Internet protocol or an X.25 protocol can be used at the interface. By encapsulation the gateway GPRS support node 144 hides the internal structure of the packet transmission network 142 from the public packet transmission network 146 so that to the public packet transmission network 146, the packet trans-mission network 142 seems like a sub-network and the public packet transmission network 146 can address packets to and receive packets from the sub-scriber terminal 162 therein.

Typically, the packet transmission network 142 is a private network, which uses an Internet protocol and transfers signaling and tunneled user data. Depending on the operator, the structure of the network 142 may vary in its architecture and protocols below the Internet protocol layer.

The public packet transmission network 146 can be the Internet, for instance, and a terminal 148, such as a server, connected thereto wishes to transmit packets to the subscriber terminals 162.

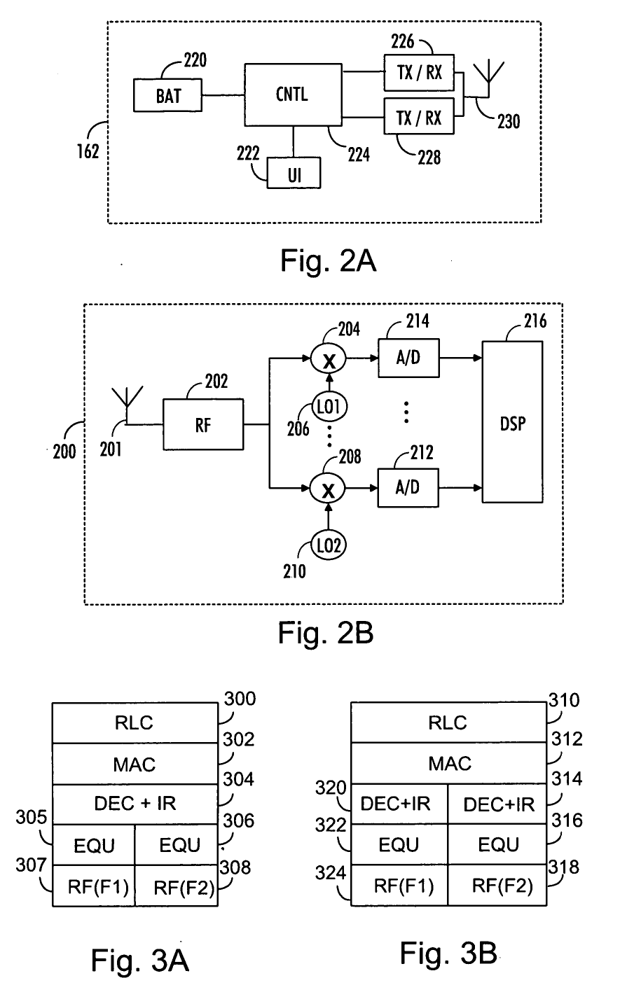

Next, a structure of a subscriber terminal will be described with reference to FIG. 2A. The subscriber terminal 162 may, for example, be a mobile subscriber terminal. The subscriber terminal 162 comprises two communication interfaces 226, 228 to provide a wireless radio connection with a serving network. The communication interfaces 226, 228 may provide connections with, for example, the GSM network thus enabling regular GSM circuit switched voice call connections but also packet switched GPRS or EPGRS connections.

The communication interfaces 226, 228 described above may use partially the same components of the subscriber terminal 162 during the operation of radio connections. The communication interfaces 226, 228 may, for example, use the same antenna 230, and/or radio frequency amplifier. Each communication interface 226, 228 may naturally have components of its own. Although the subscriber terminal 162 is described to comprise two communication interfaces, it should be appreciated that the operation of the subscriber terminal according to the invention is not restricted to the number of communication interfaces.

The subscriber terminal 162 further comprises a control unit 224 to control functions of the subscriber terminal 162. The control unit 224 handles establishment, operation and termination of radio connections in the subscriber terminal 162. The control unit 162 may be implemented with a digital signal processor with suitable software or with separate logic circuits, for example with ASIC (Application Specific Integrated Circuit).

The subscriber terminal 162 further comprises a user interface 222 connected to the control unit 224. The user interface 222 may comprise a keyboard, a microphone, a loudspeaker, a display, and/or a camera.

The communication device 162 usually comprises a voltage source 220 to provide current for the operation of the device 162. The voltage source may, for example, be a rechargeable battery.

Next, a structure of a subscriber terminal 200 will be described, wherein two receivers are employed, each configured to receive a signal modulated on a carrier with specified frequency (F1 or F2). The subscriber terminal 200 comprises at least one antenna 201, which receives two information signals with specified carrier frequencies F1 and F2. The information signals may be related to the same radio connection (for example an EGPRS connection) or the information signals may be related to different radio connections (for example a circuit switched GSM voice call connection and an EGPRS connection). Radio frequency (RF) components 202 may comprise for example an RF filter and an amplifier. From the RF components 202 the signal is fed to two multipliers 204, 208, which multiply the received information signal with a signal from local oscillators 206, 210, respectively. The local oscillator 206 provides a sinusoidal signal with center frequency F1 and the local oscillator 206 provides a sinusoidal signal with center frequency F2. Now the two information signals are converted to the base band. Next, the two base band information signals are converted into a digital form using analogue-to-digital converters 214, 212.

Digital signal processing of the information signals is carried out in a digital signal processor 216. The signal processing may comprise equalization, detection, decoding, error detection, etc.

Instead of the common antenna and/or the RF components, the subscriber terminal 200 may use separate antennas and/or RF components for both connections. The order of the operations described above may also be different. For instance a common analogue-to-digital converter may be used, in which case the analogue-to-digital conversion may precede the base band conversion.

Although the subscriber terminal 200 is described to comprise two communication receivers, it should be appreciated that the operation of the subscriber terminal 200 is not restricted to the number of receivers.

The subscriber terminal according to the invention may employ an automatic repeat request (ARQ) procedure for retransmission of erroneously received data blocks. To further improve the performance, it is possible to use an incremental redundancy, in which the receiver is equipped with a receiver memory in which all data blocks whose reception failed are stored. Failure in reception may be caused by the fact, for instance, that the conditions of the radio channel used change so quickly that it is impossible for the radio system to optimally select a code rate in advance for incoming transmission. Using the incremental redundancy allows for a better adaptation to changing conditions. Data blocks whose reception failed are retransmitted from the first transceiver. Retransmitted data blocks and stored data blocks having the same identifiers are combined, after which the receiver decodes the combined data blocks. During the combination, the amount of information available for decoding increases in comparison with the amount of information in a single data block, so decoding has a higher probability of success.

Next a layered structure of a subscriber terminal employing a GSM connection and capable of receiving information modulated on two carrier signals simultaneously will be described. The description is carried out with reference to FIG. 3A. The structure is similar to an OSI (Open Systems Interconnection) model of ISO (International Organization for Standardization), with lower layers providing services to higher layers. The two lower layers 305 to 308 are specific for two received signals, which means that the two received signals are processed independently. The lowest layer 307, 308 performs RF processing as described above with reference to FIG. 2B. The lowest layer 307 performs filtering, amplification, base band conversion and an analogue-to-digital conversion on an information signal modulated on the carrier with center frequency F1. Block 308 performs the same operations on an information signal modulated on the carrier with center frequency F2. Equalization of the two signals is also carried out separately in 305, 306.

The three highest layers may be common to both signals. A decoding and incremental redundancy block 304 performs channel decoding and takes care of incremental redundancy. The point of common coding and incremental redundancy block 304 is that erroneously received data blocks may be retransmitted using either carrier. If the coding and incremental redundancy block 304 were a separate one, retransmission should be carried out using the same carrier as the original transmission. A medium access control block 302 comprises procedures for framing and deframing data units, performing error checking and acquiring a right to use an underlying physical medium. A radio link control block 300 takes care of error-free transmission of data between a subscriber terminal and a serving base station.

Next a layered structure of a network element employing a GSM connection and capable of receiving information modulated on two carrier signals from one subscriber terminal will be described. The network element may be a base station controller, for instance. The description is carried out with reference to FIG. 3B.

As with the subscriber terminal, the network element performs RF processing and equalization on received signals modulated on two carriers separately in the blocks 316, 318, 322 and 324. Decoding and incremental redundancy block 314, 320 may be separately provided for both signals, which may be preferable in a situation, where there are two frequencies assigned to a subscriber terminal, but the subscriber terminal is configured to use only one frequency at a time. The decoding and incremental redundancy block may also be a shared one. The network element may inform the subscriber terminal as to whether the decoding and incremental redundancy block is a shared one or a separate one. Thus the subscriber terminal either transmits erroneously received blocks using the same carrier as was used in the original transmission (separate decoding and incremental redundancy blocks) or it transmits the erroneously received blocks using either carrier regardless of which carrier was used in the original transmission (common decoding and incremental redundancy block). A medium access control block 312 and a radio link control block 310 perform operations similar to those carried out by the corresponding blocks in the subscriber terminal.

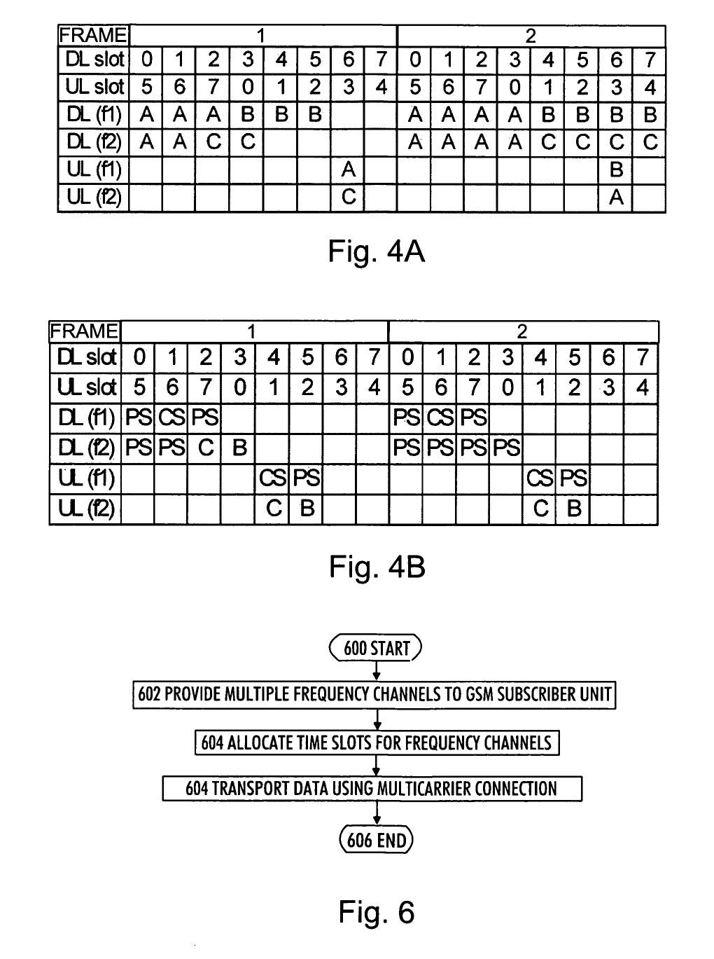

Next, the operation of a radio connection between the subscriber terminal and the network will be described with reference to FIGS. 4A and 4B. An EGPRS connection is used as an example, but the invention is not limited thereto.

When the network element receives a request for an EGPRS connection from a subscriber terminal capable of dual carrier reception, the network element assigns two frequency channels (f1 and f2) for the subscriber terminal. In addition to the assigned frequency channels, the network element may also send other connection related information to the subscriber terminal. The network element also allocates time slots in a GSM frame for both of the frequency channels. FIG. 4A describes allocation of time slots for the subscriber terminal using dual carrier EGPRS connection. The duration depicted in FIG. 4A is two GSM frames, each frame comprising eight time slots. The maximum number of time slots possible for a single carrier EGPRS connection is four time slots in a frame, when considering downlink, while for a dual carrier connection the maximum number of time slots is eight (four time slots per frequency channel). In FIG. 4A, user A is using a dual carrier connection, while user B is using a single carrier connection on a frequency channel f1, and user C is using a single carrier connection on a frequency channel f2. In the first frame, a total of five time slots is allocated for user A (three for frequency channel f1 connection and two for the frequency channel f2 connection), while only three time slots for user B and two slots for user C. In the second frame the maximum number of time slots is allocated for all users (four time slots for users B and C, and a total of eight time slots for user A). The dual carrier connection of user A enables more time slots to be allocated for user A, which increases the bit rate considerably.

In the uplink case, user A may use either frequency channel for transmission of data. The network may send a command to the subscriber terminal, the command comprising the frequency channel to be used as well as a command to start transmitting data using the defined time slot (called dynamic allocation). The network ensures that there is a certain guard period between the transmission of the command and the start of the transmission of the subscriber terminal. The network also ensures that the subscriber terminal has enough time to switch to a correct frequency channel. In addition to dynamic allocation, extended dynamic allocation may also be used. In this case, the network sends a command comprising the frequency channel to be used as well as a command to start transmitting data using a number of defined time slots. In FIG. 4A, user A transmits uplink data using the frequency channel f1 in the first frame and the frequency channel f2 in the second frame, while users B and C only use a single frequency channel.

Although FIG. 4A describes a situation where a number of time slots is allocated for both frequency channels assigned to user A in the downlink case, it is also possible to assign the same time slot or slots for both frequency channels assigned to user A in the uplink case. Thus, user A could transmit data to the network using the both frequency channels simultaneously.

FIG. 4B illustrates allocation of frequency channels and time slots when a circuit switched connection (a voice call, for example) and a packet switched connection (EGPRS connection, for example) operate simultaneously in one subscriber terminal capable of dual carrier connection. The network may assign one frequency channel for the circuit switched connection and the packet switched connection may be using either the other frequency channel or the both frequency channels. In the example of FIG. 4B, a frequency channel f1 is allocated for the circuit switched connection, and the packet switched connection uses the both frequency channels f1 and f2. The network has allocated one time slot in a GSM frame for the circuit switched connection for both uplink and downlink. It is preferable that the same time slot in a frame is allocated for the circuit switched connection, since the connection requires continuous transport of data. Any additional time slots available may then be allocated for packet switched connections. There are also time slots allocated for users B and C in the frequency channel f2.

Although FIG. 4A describes a situation where a number of time slots is allocated for both frequency channels assigned to user A in the downlink case, it is also possible to assign the same time slot or slots for both frequency channels assigned to user A in the uplink case. Thus user A could transmit data to the network using the both frequency channels simultaneously. The situation is the same as in the example of FIG. 4B. Packet switched data could be transported using both frequency channels in the same time slot also in the uplink case.

Instead of using a dual carrier connection for transport of data using two frequency channels, it is possible to use the dual carrier connection for transport of data using one frequency channel by utilizing a multiple input multiple output (MIMO) radio channel. This is possible in radio environments which introduce variable multipath propagation of the radio signal. When two signals sent to the receiver via different paths do not correlate too much, it is possible to separate these signals in the receiver. It is thus possible to utilize these two radio paths and increase the data transport capacity of the system by transporting different data via these two radio paths. Using MIMO transmission requires, however, multiple antennas in both the transmitter and the receiver. The number of possible MIMO transmission paths depends on the number of antennas in the transmitter and in the receiver. The maximum number of possible MIMO transmission paths is the number of transmitter antennas multiplied by the number of receiver antennas. In some cases the actual number of MIMO transmission paths is lower due to the too-high correlation properties between a number of paths. The too-high correlation results in an inability to separate the different paths in the receiver. An additional signal processing capacity is also needed in the subscriber terminal and in the network, if compared to the regular single antenna systems.

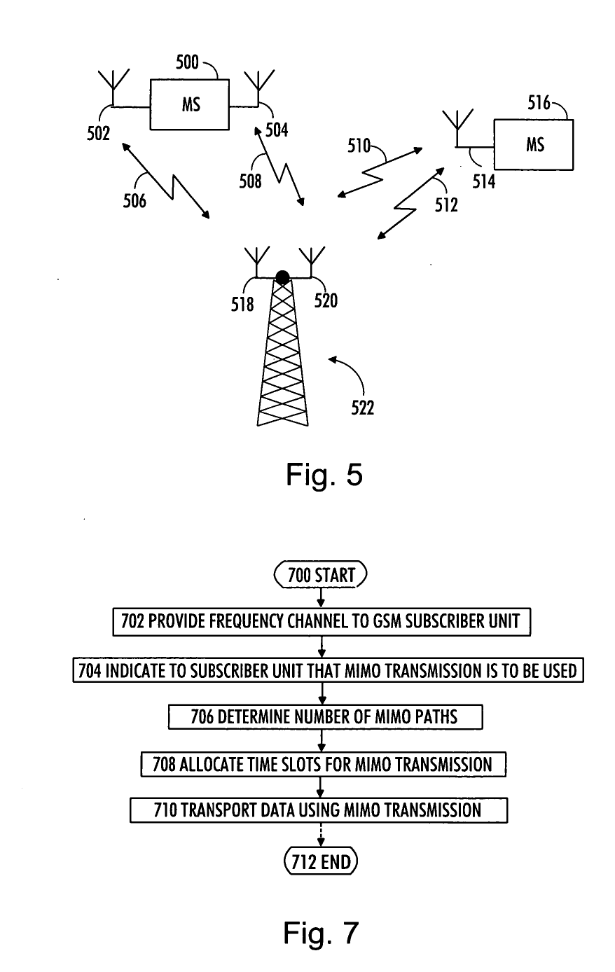

FIG. 5 illustrates a subscriber terminal 500 capable for MIMO connection. The subscriber terminal may use antennas 502, 504 for either MIMO connection or a conventional single input single output (SISO) connection. In the latter case, the subscriber terminal may use its dual carrier connection capability for transport of data using two frequency channels as described above.

A base station 522 also has to comprise at least two antennas 518, 520 in order to enable a MIMO transmission. An indication to use the MIMO transmission may come from the network in the form of a command, where the network only assigns one frequency channel for the subscriber terminal 500, but assigns for example two different training sequences for the subscriber terminal. A training sequence is used, for example, for synchronization and equalization, and is known in both the transmitter and the receiver. The subscriber terminal may then use one training sequence for a first radio link 506 between the subscriber terminal 500 and a base station 522, and the other training sequence for a second radio link 508. Different data may then be transmitted through different links, thus increasing capacity of the radio system.

In the above case the MIMO transmission would comprise four different MIMO paths. One path between antennas 502 and 518, one path between antennas 502 and 520, one path between antennas 504 and 518, and one path between antennas 504 and 520. The number of MIMO transmission paths to be used may be determined in the network, based on the number of antennas in the subscriber terminal and in the base station, and based on the known correlation properties of the MIMO channel. The network element comprises a control unit, which comprises means for determining the number of MIMO transmission paths and indicating this to the subscriber terminal. After determining the number of MIMO transmission paths, and indicating that to the subscriber terminal (by number of training sequences, for example), the network may allocate time slots for each MIMO transmission path independently. The procedure is similar to the procedure described in relation to the multiple frequency channels allocated for a subscriber terminal. The same time slot in a GSM frame may be allocated for several MIMO transmission paths.

The base station 522 may also use its multiple antennas with radio connections 510, 512 between subscriber terminals 516 comprising only a single antenna 514. In these cases the multiple antennas of the base station may be used, for example, for diversity gain in both transmission and reception.

The subscriber terminals and the network elements according to the invention are compatible with the existing networks and subscriber terminals. Using the dual (or multi) carrier EGPRS connections includes the same constraints as the single carrier GPRS and EGPRS. Such a constraint is for example the specification that the network must transport every 18^{th} time slot using the Gaussian minimum shift keying modulation, which is a common modulation for all GPRS connections. This constraint is for synchronization purposes. In order to increase data rate the EGPRS connections may also use 8-PSK (phase shift keying). The incorporation of MIMO connections into the EGPRS does not affect this constraint.

FIG. 6 illustrates a process for transporting data with multiple frequency channels assigned for one subscriber terminal. A subscriber terminal has to be capable of transporting data using multiple frequency channels simultaneously.

The process starts in 600. A network provides multiple frequency channels for a subscriber terminal in 602. The subscriber terminal may use these frequency channels for either uplink or downlink data transport. The frequency channels may be used simultaneously for transport of data. The network allocates time slots for both frequency channels independently in 604. The maximum possible number of allocated time slots in a GSM frame is thus much higher than that in one frequency channel case. Data is transported between the subscriber terminal and the network using the multiple frequency channels and allocated time slots in 604. The process ends in 606.

FIG. 7 illustrates a process for transporting data using MIMO transmission between a subscriber terminal and a network. The subscriber terminal and a serving base station have to be capable of MIMO transmission.

The process starts in 700. A network provides the subscriber terminal with a frequency channel to be used in transmission and reception of data in 702. The network indicates to the subscriber terminal that MIMO transmission is to be used in 704. The term “MIMO transmission” also refers to receiving data transmitted by utilizing a MIMO channel. An indication to use MIMO transmission may be sent in the form of several training sequences. The network determines the number of MIMO transmission paths to be used. The number of training sequences sent to the subscriber terminal may indicate to the subscriber terminal the precise number of MIMO transmission paths to be used. The time slots in a GSM frame are allocated for each MIMO transmission path independently in 708. Data is transported between the subscriber terminal and the network using MIMO transmission in 710. The process ends in 712.

Even though the invention has been described above with reference to an example according to the accompanying drawings, it is clear that the invention is not restricted thereto but it can be modified in several ways within the scope of the appended claims. Particularly even though the invention has been described mainly using subscriber terminals capable of dual carrier reception, the invention is not limited thereto, but additional carriers may also be used. Several carriers may also be used for simultaneous transmission of data from the subscriber terminal to the network.

1. A data transmission method for a Global System for Mobile Communications, the method comprising:
providing a subscriber terminal configured to transport data using multiple carrier signals with at least two frequency channels to transport the data;
allocating time slots in a Global System for Mobile Communications frame for the frequency channels provided to the subscriber terminal; and
transporting the data according to the allocated time slots using the frequency channels provided to the subscriber terminal.

2. The method of claim 1, wherein the allocation of the time slots for the frequency channels provided to the subscriber terminal comprise:
enabling simultaneous transport of the data using the frequency channels.

3. The method of claim 1, wherein the allocation of the time slots for the frequency channels provided to the subscriber terminal comprise:
enabling simultaneous download of the data using the frequency channels.

4. The method of claim 1, wherein the transporting of the data is performed using an Enhanced Data Rate for Global Evolution technology.

5. The method of claim 1, further comprising:
using the frequency channels for simultaneous circuit switched and packet switched connections.

6. A subscriber terminal for a Global System for Mobile Communications, the subscriber terminal comprising:
at least one transmitter for transmitting data;
at least one receiver for receiving the data; and
a control unit configured to
receive a first command to use at least two specified frequency channels to transport the data,
receive a second command to use specified time slots in a Global System for Mobile Communications frame for the specified frequency channels, and
transport the data according to the specified time slots using the specified frequency channels.

7. A network element for a Global System for Mobile Communications, the network element comprising:
at least one transmitter for transmitting data;
at least one receiver for receiving the data; and
a control unit configured to
provide a subscriber terminal with at least two frequency channels to transport the data,
allocate time slots in a Global System for Mobile Communications frame for the frequency channels provided to the subscriber terminal, and
transport the data according to the allocated time slots using the frequency channels provided to the subscriber terminal.

8. An arrangement for a Global System for Mobile Communications, comprising:
a subscriber terminal comprising
means for receiving a first command to use at least two specified frequency channels to transport data,
means for receiving a second command to use specified time slots in a Global System for Mobile Communications frame for the specified frequency channels, and
means for transporting the data according to the specified time slots using the specified frequency channels; and
a network element comprising
means for providing the subscriber terminal with the specified frequency channels to transport the data,
means for allocating the specified time slots in the Global System for Mobile Communications frame for the specified frequency channels provided to the subscriber terminal, and
means for transporting the data according to the specified time slots using the specified frequency channels provided to the subscriber terminal, wherein the subscriber terminal and the network element are in radio contact with each other.

9. A subscriber terminal for a Global System for Mobile Communications, the subscriber terminal comprising:
means for receiving a first command to use at least two specified frequency channels to transport data;
means for receiving a second command to use specified time slots in a Global System for Mobile Communications frame for the provided frequency channels; and
means for transporting the data according to the specified time slots using the specified frequency channels.

10. A network element for a Global System for Mobile Communications, the network element comprising:
means for providing a subscriber terminal with at least two frequency channels to transport data;
means for allocating time slots in a Global System for Mobile Communications frame for the frequency channels provided to the subscriber terminal; and
means for transporting the data according to the allocated time slots using the frequency channels provided to the subscriber terminal.

11. A computer program product encoding a computer program of instructions for executing a computer process for transporting data in a Global System for Mobile Communications, the process comprising:
providing a subscriber terminal configured to transport the data using multiple carrier signals with at least two frequency channels to transport the data;
allocating time slots in a Global System for Mobile Communications frame for the frequency channels provided to the subscriber terminal; and
transporting the data according to the allocated time slots using the frequency channels provided to the subscriber terminal.

12. A computer program distribution medium readable by a computer and encoding a computer program of instructions for executing a computer process for transporting data in a Global System for Mobile Communications, the process comprising:
providing a subscriber terminal configured to transport the data using multiple carrier signals, with at least two frequency channels to transport the data;
allocating time slots in a Global System for Mobile Communications frame for the frequency channels provided to the subscriber terminal; and
transporting the data according to the allocated time slots using the frequency channels provided to the subscriber terminal.

13. The computer program distribution medium of claim 12, wherein the distribution medium comprises a computer readable medium, a program storage medium, a record medium, a computer readable memory, a computer readable software distribution package, a computer readable signal, a computer readable telecommunications signal, or a computer readable compressed software package.

14. A data transmission method for a Global System for Mobile Communications, the method comprising:
providing a subscriber terminal configured to transport data using multiple carrier signals with a frequency channel to transport the data;
indicating to the subscriber terminal that the provided frequency channel is to be used for multiple input multiple output transmission of the data;
determining a number of multiple input multiple output transmission paths between the subscriber terminal and a base station;
allocating time slots in a Global System for Mobile Communications frame for the multiple input multiple output transmission paths; and
transporting the data according to the allocated time slots provided to the subscriber terminal using the multiple input multiple output transmission.

15. The method of claim 14, wherein the indication to use the multiple input multiple output transmission of the data is provided with a number of training sequences provided to the subscriber terminal.

16. The method of claim 14, further comprising:
transporting different data via different multiple input multiple output transmission paths.

17. A subscriber terminal for a Global System for Mobile Communications, the subscriber terminal comprising:
at least one transmitter for transmitting data;
at least one receiver for receiving the data;
at least two antennas to enable multiple input multiple output transmission and reception of the data; and
a control unit configured to
receive a first command to use a specified frequency channel to transport the data,
receive an indication to use the specified frequency channel for the multiple input multiple output transmission of the data,
receive a number of multiple input multiple output transmission paths to be used in the transmission or reception of the data,
receive a second command to use specified time slots in a Global System for Mobile Communications frame for the multiple input multiple output transmission paths, and
transport the data according to the specified time slots provided to the subscriber terminal using the multiple input multiple output transmission.

18. A network element for a Global System for Mobile Communications, the network element comprising:
at least one transmitter for transmitting data;
at least one receiver for receiving the data; and
a control unit configured to
provide a subscriber terminal configured to transport the data using multiple carrier signals with a frequency channel to transport the data,
indicate to the subscriber terminal that the provided frequency channel is to be used for multiple input multiple output transmission of the data,
determine a number of multiple input multiple output transmission paths between the subscriber terminal and a base station,
allocate time slots in a Global System for Mobile Communications frame for the multiple input multiple output transmission paths, and
transport the data according to the allocated time slots provided to the subscriber terminal using the multiple input multiple output transmission.

19. An arrangement for a Global System for Mobile Communications, comprising: a subscriber terminal comprising
means for receiving a first command to use a specified frequency channel to transport data,
means for receiving an indication to use the specified frequency channel for multiple input multiple output transmission of the data,
means for receiving a number of multiple input multiple output transmission paths to be used in a transmission or reception of the data,
means for receiving a second command to use specified time slots in a Global System for Mobile Communications frame for the multiple input multiple output transmission paths, and
means for transporting the data according to the specified time slots provided to the subscriber terminal using the multiple input multiple output transmission; and
a network element comprising
means for providing the subscriber terminal configured to transport the data using multiple carrier signals with the specified frequency channel to transport the data,
means for indicating to the subscriber terminal that the specified frequency channel is to be used for the multiple input multiple output transmission of the data,
means for determining the number of multiple input multiple output transmission paths between the subscriber terminal and a base station,
means for allocating the specified time slots in the Global System for Mobile Communications frame for the multiple input multiple output transmission paths, and
means for transporting the data according to the specified time slots provided to the subscriber terminal using the multiple input multiple output transmission, wherein the subscriber terminal and the network element are in radio contact with each other.

20. A subscriber terminal for a Global System for Mobile Communications, the subscriber terminal comprising:
means for receiving a first command to use a specified frequency channel to transport data;
means for receiving an indication to use the specified frequency channel for multiple input multiple output transmission of the data;
means for receiving a number of multiple input multiple output transmission paths to be used in a transmission or reception of the data;
means for receiving a second command to use specified time slots in a Global System for Mobile Communications frame for the multiple input multiple output transmission paths; and
means for transporting the data according to the specified time slots provided to the subscriber terminal using the multiple input multiple output transmission.

21. A network element for a Global System for Mobile Communications, the network element comprising:
means for providing a subscriber terminal configured to transport data using multiple carrier signals with a frequency channel to transport the data;
means for indicating to the subscriber terminal that the provided frequency channel is to be used for multiple input multiple output transmission of the data;
means for determining a number of multiple input multiple output transmission paths between the subscriber terminal and a base station;
means for allocating time slots in a Global System for Mobile Communications frame for the multiple input multiple output transmission paths; and
means for transporting the data according to the allocated time slots provided to the subscriber terminal using the multiple input multiple output transmission.

22. A computer program product encoding a computer program of instructions for executing a computer process for transporting data in a Global System for Mobile Communications, the process comprising:
providing a subscriber terminal configured to transport the data using multiple carrier signals with a frequency channel to transport the data;
indicating to the subscriber terminal that the frequency channel is to be used for multiple input multiple output transmission of the data;
determining a number of multiple input multiple output transmission paths between the subscriber terminal and a base station;
allocating time slots in a Global System for Mobile Communications frame for the multiple input multiple output transmission paths; and
transporting the data according to the allocated time slots provided to the subscriber terminal using the multiple input multiple output transmission.

23. A computer program distribution medium readable by a computer and encoding a computer program of instructions for executing a computer process for transporting data in a Global System for Mobile Communications, the process comprising:
providing a subscriber terminal configured to transport the data using multiple carrier signals with a frequency channel to transport the data;
indicating to the subscriber terminal that the frequency channel is to be used for multiple input multiple output transmission of the data;
determining a number of multiple input multiple output transmission paths between the subscriber terminal and a base station;
allocating time slots in Global System for Mobile Communications frame for the multiple input multiple output transmission paths;
transporting the data according to the allocated time slots provided to the subscriber terminal using the multiple input multiple output transmission.

24. The computer program distribution medium of claim 23, wherein the distribution medium comprises a computer readable medium, a program storage medium, a record medium, a computer readable memory, a computer readable software distribution package, a computer readable signal, a computer readable telecommunications signal, or a computer readable compressed software package.
